(19) United States
(12) Patent Application Publication
(10) Pub. No.: US 2011/0218089 A1
(43) Pub. Date: Sep. 8, 2011

(54) COMPACT DUNNAGE CONVERSION MACHINE

(75) Inventors: Raimond Demers, Landgraaf (NL); Pedro Erik Willem Winkens, Vaals (NL)

(73) Assignee: RANPAK CORP., Concord Township, OH (US)

(21) Appl. No.: 13/128,732

(22) PCT Filed: Nov. 17, 2009
(86) PCT No.: PCT/US2009/064843

§ 371 Date: May 11, 2011

Related U.S. Application Data
(60) Provisional application No. 61/115,269, filed on Nov. 17, 2008.

(51) Int. Cl. B31B 43/00

(52) U.S. Cl. 493/338

(57) ABSTRACT

A dunnage conversion machine includes a conversion assembly having a pair of rotating members to feed stock material along a path between the rotating members mounted for rotation about respective axes to feed stock material along a path between the rotating members, and a chute that bounds the path between the rotating members. One of the rotating members and a portion of the chute are mounted for common movement toward and away from the other rotating member and another portion of the chute. The floating rotating member and floating portion of the chute are part of a subassembly that can be removed from the conversion assembly as a unit, separate from another portion of the chute and the other rotating member.

This application claims the benefit of U.S. Provisional Patent Application No. 61/115,269, filed Nov. 17, 2009, which is incorporated herein by reference.

### FIELD OF THE INVENTION

The present invention is directed to a compact dunnage conversion machine and improvements to dunnage conversion machines.

### BACKGROUND

Dunnage conversion machines convert a stock material into a dunnage product that can be used to pack articles and thus minimize or prevent damage during shipment. The dunnage conversion machines, also referred to as dunnage converters, include a conversion mechanism that converts a stock material into a relatively thicker and lower density dunnage product as the stock material moves through the conversion mechanism from an upstream end toward an outlet at a downstream end.

An exemplary type of dunnage conversion machine converts a sheet stock material, such as paper, into a dunnage product. Typically a substantially continuous sheet material is inwardly and longitudinally crumpled, and fixed in its crumpled state. Exemplary dunnage conversion machines of this type are disclosed in U.S. Pat. Nos. 4,717,613; 5,123,889; and 5,803,893.

### SUMMARY

The present invention provides a number of improved features for a compact dunnage conversion machine for converting a sheet stock material into a relatively thicker and less dense dunnage product.

The foregoing and other features of the invention are hereinafter fully described and particularly pointed out in the claims, the following description and annexed drawings setting forth in detail certain illustrative embodiments of the invention, these embodiments being indicative, however, of but a few of the various ways in which the principles of the invention may be employed.

### BRIEF DESCRIPTION OF THE DRAWINGS

FIG. 1 is a perspective view of a dunnage conversion machine provided by the present invention in a vertical orientation.

FIG. 2 is a perspective view of a downstream end of the dunnage conversion machine of FIG. 1.

FIG. 3 is a perspective view of the dunnage conversion machine of FIG. 1 with front portions of the housing removed to display its interior components.

FIG. 4 is a perspective view of an upstream end of the dunnage conversion machine of FIG. 3.

FIG. 5 is an enlarged view of a stock supply assembly portion of the dunnage conversion machine of FIG. 1.

FIG. 6 is a perspective view of a stock supply assembly portion of a dunnage conversion machine such as that shown in FIG. 1 with a stack of fan-folded sheet stock material.

FIG. 7 is a perspective view of a dunnage conversion machine provided by the present invention in a substantially horizontal orientation.

FIG. 8 is a perspective view of an upstream portion of the dunnage conversion machine of FIG. 7.

FIG. 9 is a perspective view of a downstream portion of a conversion assembly in the dunnage conversion machine of FIG. 7.

FIG. 10 is a perspective view of FIG. 9 illustrating how stock material is loaded in the conversion assembly.

FIG. 11 is another perspective view of the conversion assembly shown in FIG. 9.

FIG. 12 is another perspective view of a downstream portion of the conversion assembly.

FIG. 13 is an enlarged perspective view of a portion of the conversion assembly of FIG. 12.

FIG. 14 is a perspective view of a portion of the downstream portion of the conversion assembly of FIG. 12 illustrating how a portion of the conversion assembly can be removed as a unit.

FIG. 15 is a perspective view of a downstream portion of the conversion assembly of FIG. 14 with a portion of the conversion assembly removed.

FIG. 16 is a perspective view of a downstream portion of the dunnage conversion machine of FIG. 7.

FIG. 17 is another perspective view of a downstream portion of the dunnage conversion machine of FIG. 7.

### DETAILED DESCRIPTION

The present invention provides a number of improved features in a compact dunnage conversion machine for converting a sheet stock material into a relatively thicker and less dense dunnage product. These features help to minimize or prevent stock material from jamming in the conversion process, facilitate inspection and maintenance procedures, provide for the support of a supply of stock material in different forms, and help to maintain more uniform tension in a multi-ply sheet stock material.

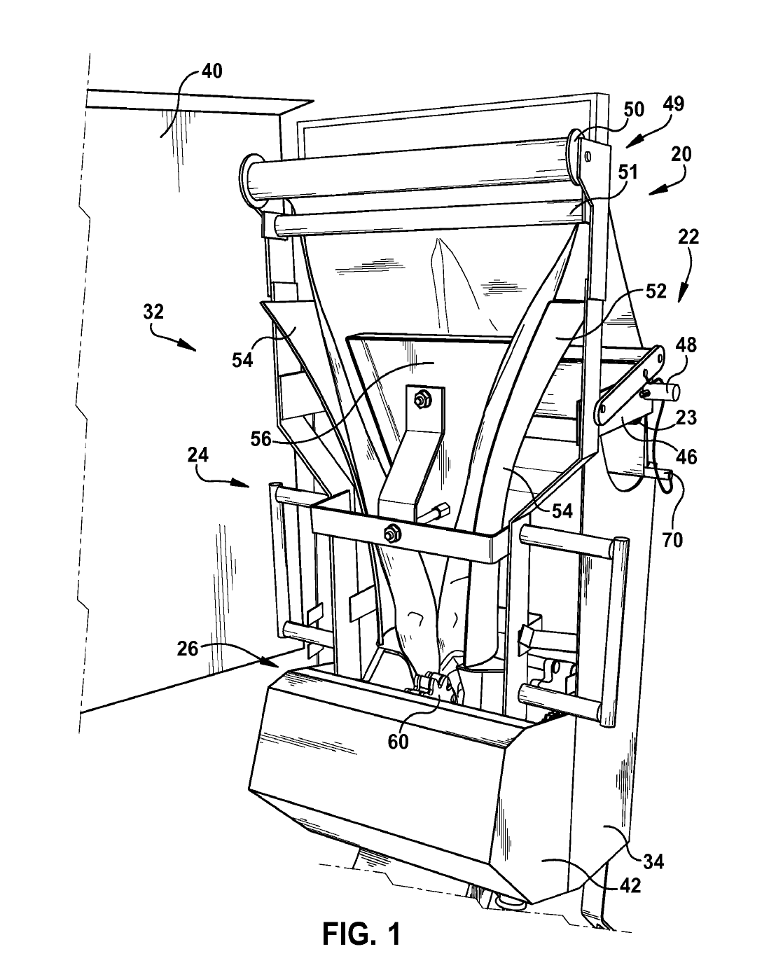

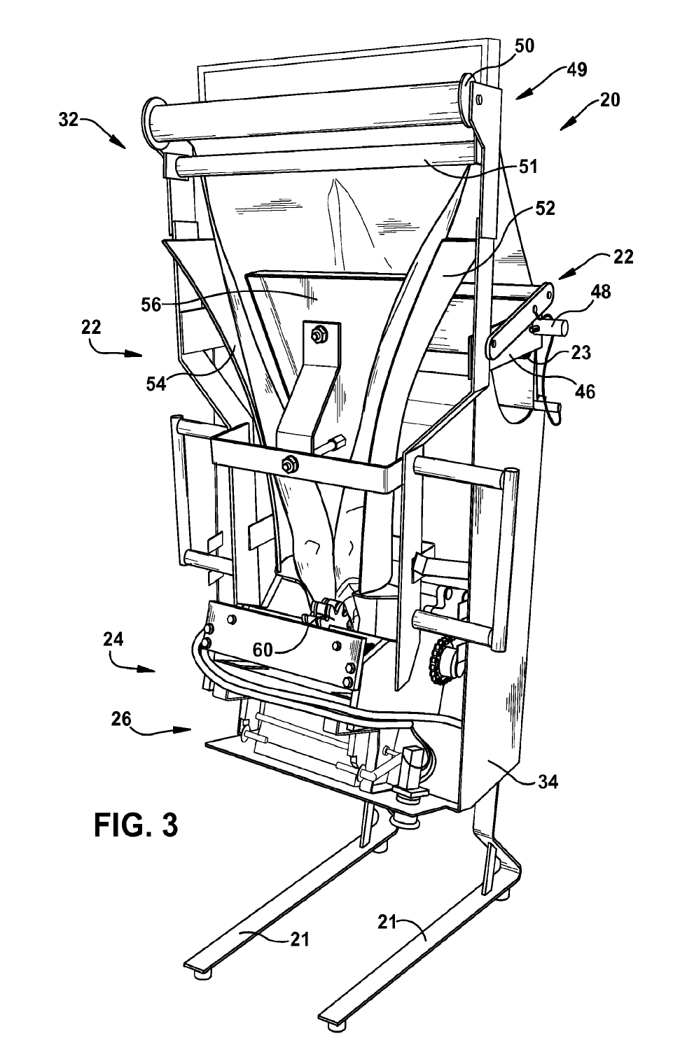

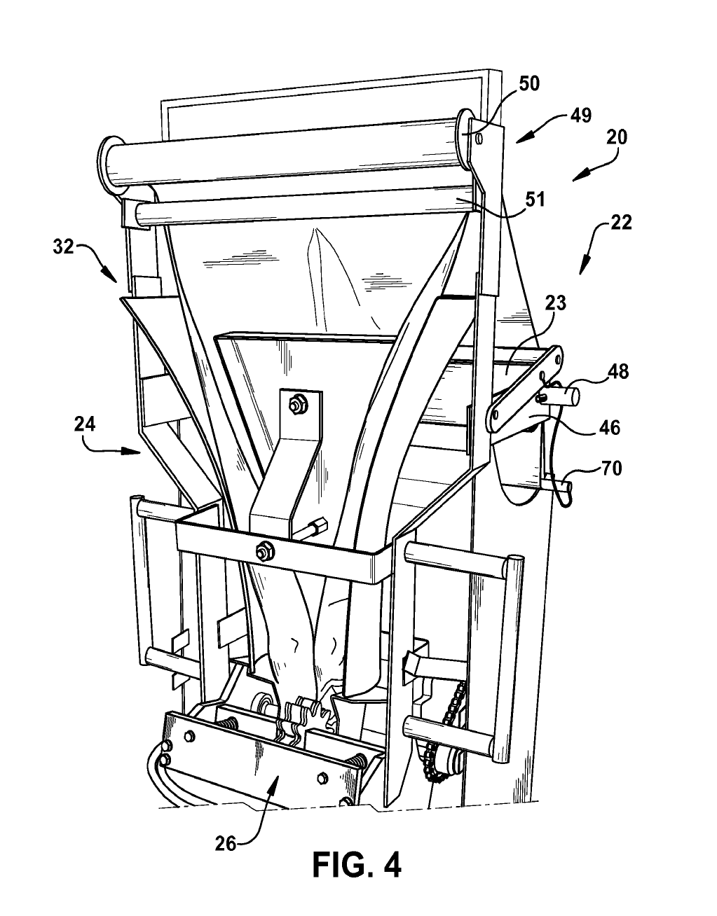

Turning now to the drawings, FIGS. 1-4 provide various views of an exemplary dunnage conversion machine 20 provided in accordance with the present invention. The conversion machine in these figures is shown in an upright or vertical orientation and includes a pair of feet 21 to support the machine on a tabletop or other surface to output dunnage at a suitable height. The conversion machine 20 includes a stock supply assembly 22 with a roll 23 of sheet stock material, a forming assembly 24, a feeding/connecting assembly 26, and a severing assembly 30. A conversion assembly 32 generally includes the forming assembly 24, the feeding/connecting assembly 26 and the severing assembly 30. And a housing 34 typically encloses a substantial portion of the conversion assembly 32.

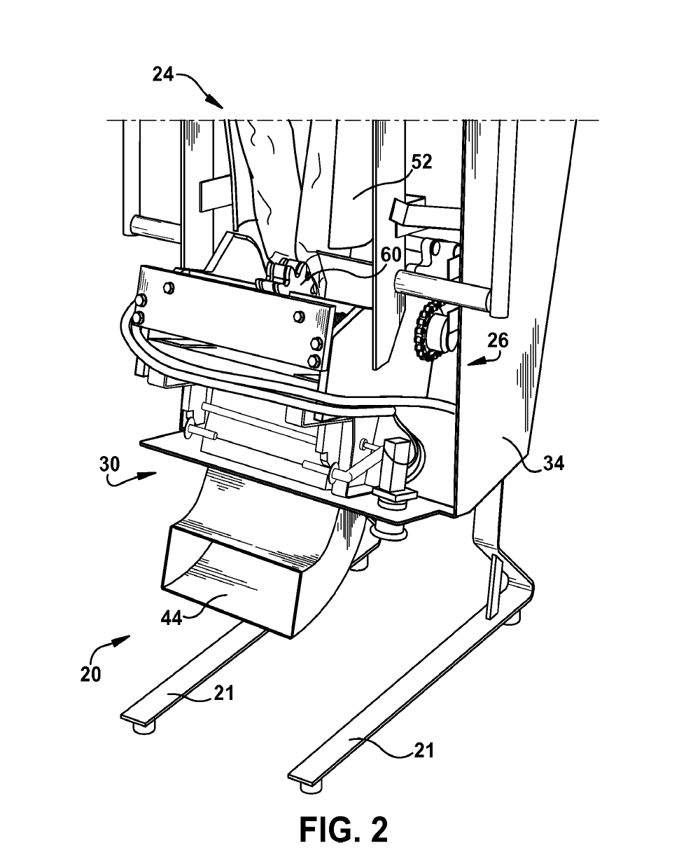

In FIG. 1, a door 40 of the housing 34 has been opened and it is removed from subsequent figures. The door 40 in this embodiment includes only one panel, but the door 40 alternatively could include more than one panel, so that the door 40 folds out of the way, accordion fashion, or opens from the center, toward either lateral sides of the machine 20 or toward respective upstream and downstream ends of the machine 20. Another panel 42 of the housing 34 covers the severing assembly 30 downstream of the door panel 40 and also is removed from subsequent figures. An output chute 44 portion of the housing 32, shown in FIG. 2, also is removed in subsequent figures. With just these panels 40, 42, and 44 removed, most of the internal components of the machine 20 are accessible for inspection and repair.

In operation, the feeding/connecting assembly 26 draws the sheet stock material, in this case a multi-ply paper, from the stock supply assembly 22. From the stock supply assembly 22 the stock material travels from an upstream end to a downstream end of the conversion assembly 32 as it is converted into a dunnage product. This upstream-to-downstream direction generally is referred to as a longitudinal direction. The stock supply assembly 22 in this instance includes a pair of laterally-spaced supports 46 that support the roll 23 therebetween. The roll 23 has a hollow cylindrical core about which the one or more plies of sheet stock material are wound. The supports 46 support a rod 48 extending through the core of the roll 23 so that the roll is free to rotate as the stock material is unwound therefrom. The stock material then travels to a constant entry assembly 49 with transverse rollers 50 and 51 that provides a consistent entry point for the stock material that each ply shares in common before traveling to the upstream end of the forming assembly 24.

From the stock supply assembly 22, the stock material travels downstream through the forming assembly 24 which inwardly gathers and crumples lateral portions of the stock material to form a crumpled strip of dunnage. The forming assembly 24 includes a longitudinally converging chute 52 with laterally and transversely converging side walls 54 that inwardly turn the lateral portions of the stock material until they overlap a central portion of the stock material. A forming member in the form of a tray 56 is mounted in the chute 52. The tray 56 has a generally planar triangular shape with low side walls and is spaced from a bottom or back side of the chute to minimize crumpling in a central portion of the stock material. Other types of forming member are known and may provide suitable alternatives. The chute 52 defines a path for the stock material through the forming assembly 24 and guides the stock material to the feeding/connecting assembly 26. One side of the chute 52, typically the front or top side depending on the orientation of the conversion machine 20, is open. The open side of the chute 52 is adjacent a door of the housing 34. Employing a chute 52 having an open side and using a door 40 that opens adjacent the open side of the chute makes it easier to access the inside of the chute for inspection, maintenance, loading a new supply of sheet stock material, and clearing any stock material that has jammed in the conversion assembly 32, including the forming assembly 24 and/or the feeding/connecting assembly 26 downstream of the forming assembly 24.

The feeding/connecting assembly 26 draws the stock material through the forming assembly 24 and connects the overlapping layers in a central band of the crumpled strip by coining or stitching, forming a strip of dunnage having lateral crumpled pillow portions and a relatively thinner and narrower central connected band. The feeding/connecting assembly 26 includes a pair of transversely-opposed rotating members 60 (one shown) mounted for rotation about respective parallel axes to feed the stock material along a path between the rotating members as they connect the overlapping layers. The illustrated rotating members 60 are commonly referred to as stitching gears. From the feeding/connecting assembly 26 the strip of dunnage passes through a severing assembly 30 that severs, such as by cutting, discrete lengths of dunnage from the strip.

Similar conversion mechanisms are known. But the dunnage conversion machine provided by the invention provides some improvements. Further details of the conversion machine provided by the present invention are set forth in the following paragraphs.

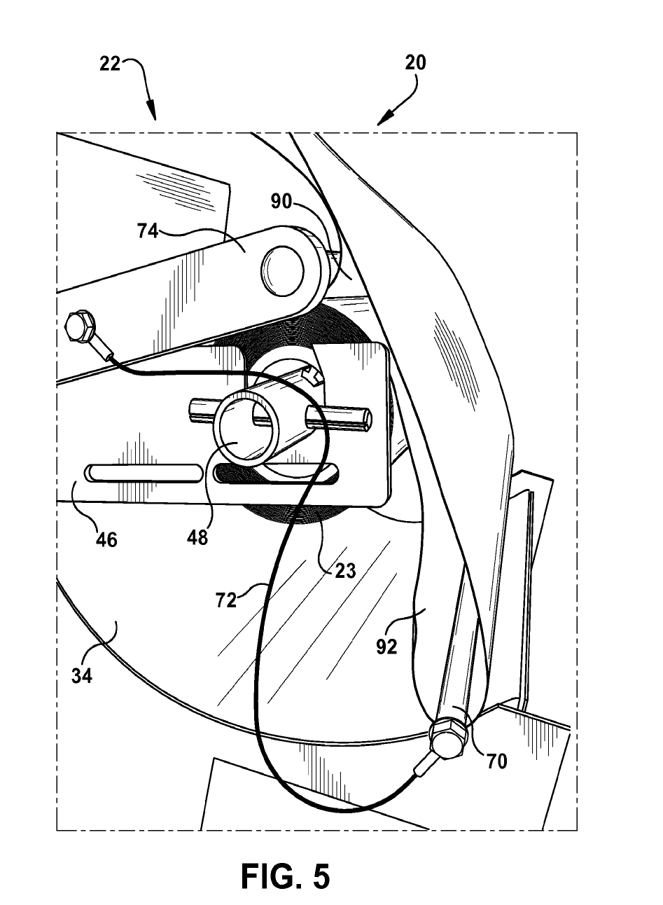

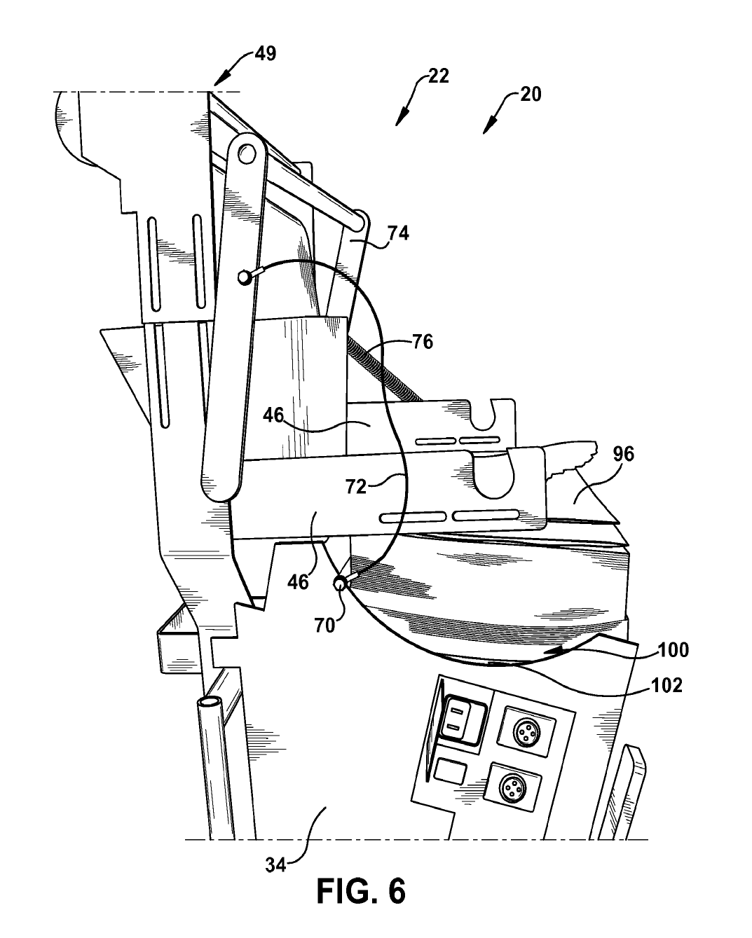

Returning now to the stock supply assembly 22, a portion of which is shown in FIG. 5, the stock supply assembly includes a transverse member 70 that defines separate paths for respective plies from the roll 23 to a common transverse member 50 in the constant-entry assembly 49 at an upstream end of the conversion assembly 32. In the illustrated embodiment, the transverse member 70 is connected to the conversion machine 20 by a leash 72 connected to each end, laterally outside the stock roll supports 46. Alternatively, the transverse member can ride in a slot in a portion of the machine's frame. A brake 74 is biased against an outer surface of the stock roll 23 by a spring 76 (FIG. 6) to minimize or prevent the stock roll from continuing to rotate after the feeding/connecting assembly 26 stops drawing stock material from the roll. In the illustrated embodiment the leashes 72 are connected to an arm of the brake 74. The stock material in this embodiment has a plurality of plies, specifically two plies. One ply 90 comes off the roll 23 and travels to the common transverse member 50 and the constant entry assembly 49. The other ply 92, in this case the inner ply, travels around the transverse member 70 before traveling to the constant entry assembly 49. The path of this inner ply 92 extends substantially vertically downward as it approaches the transverse member 70, and substantially vertically upward as it leaves the transverse member 70 to define a U-shape path between the stock roll supports 46 and the stock roll 23 supported thereon to the common transverse member 50. An advantage of this arrangement derives from the fact that when dispensing a multi-ply sheet stock material from a roll, the plies generally are consumed at different rates. By directing one ply to a longer path, any slack in the inner ply can be taken up before that ply enters the conversion assembly. This results in more consistent tension in respective plies and a better quality dunnage product.

Another advantage provided by this machine 20 is the ability to use either the roll 23 of sheet stock material in the manner described above, or a stack 96 of fan-folded sheet stock material, as shown in FIG. 6. The spring-biased brake 74 is not needed with a fan-folded stack, so it can be secured out of the way, removed or omitted altogether. The stack 96 of sheet stock material typically includes only one ply, in which case the transverse member 70 also is not needed. Although even with a multi-ply stock material, when it is folded into a fan-folded stack the plies generally are consumed at a more consistent rate and the transverse member probably still can be omitted or removed.

As shown in the figures, the housing 34 has a top wall 100 that is offset from an axis of the common member 50 and includes a platform 102 offset from the longitudinal axis of the conversion assembly 32 that supports the stack 96. Accordingly, the stock supply assembly 22 includes the pair of laterally-spaced apart supports 46 for optionally supporting a roll 23 of sheet stock material (FIG. 1), and the offset platform 102 provided by the top wall 100 of the housing 34 for optionally supporting a stack 96 of sheet stock material between the supports 46. Both of these features make it easier to support a supply of sheet stock material in a compact space, whether the stock material is provided in the form of a roll or a stack.

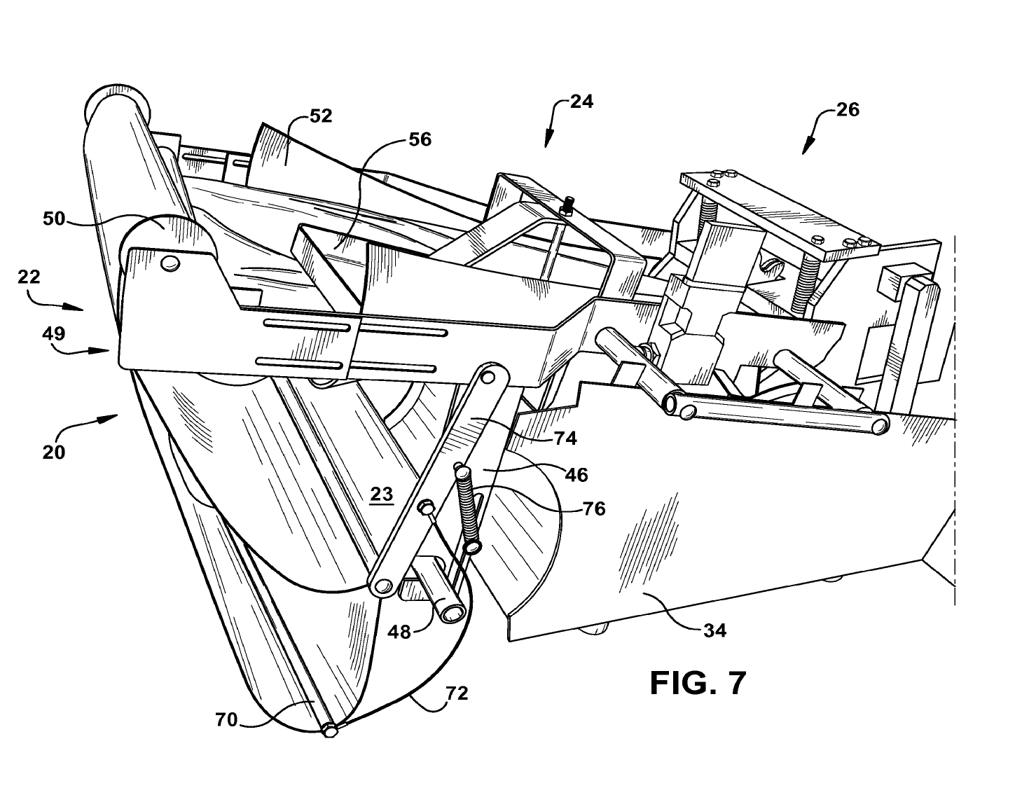

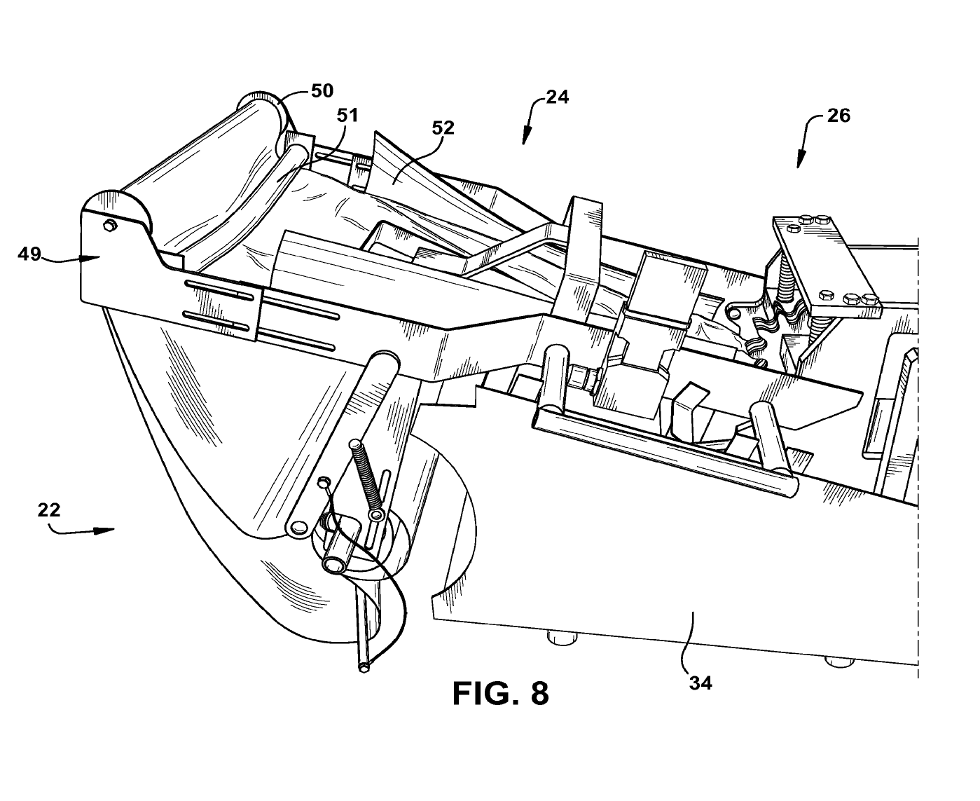

As shown beginning in FIGS. 7 and 8, the conversion machine 20 also can be provided in generally horizontal orientation. In this configuration, the stock supply assembly 22 can only support a stock roll 23, although a stack of sheet stock material could be provided on the same surface that supports the conversion machine or anywhere else that is convenient to the constant-entry assembly 49.

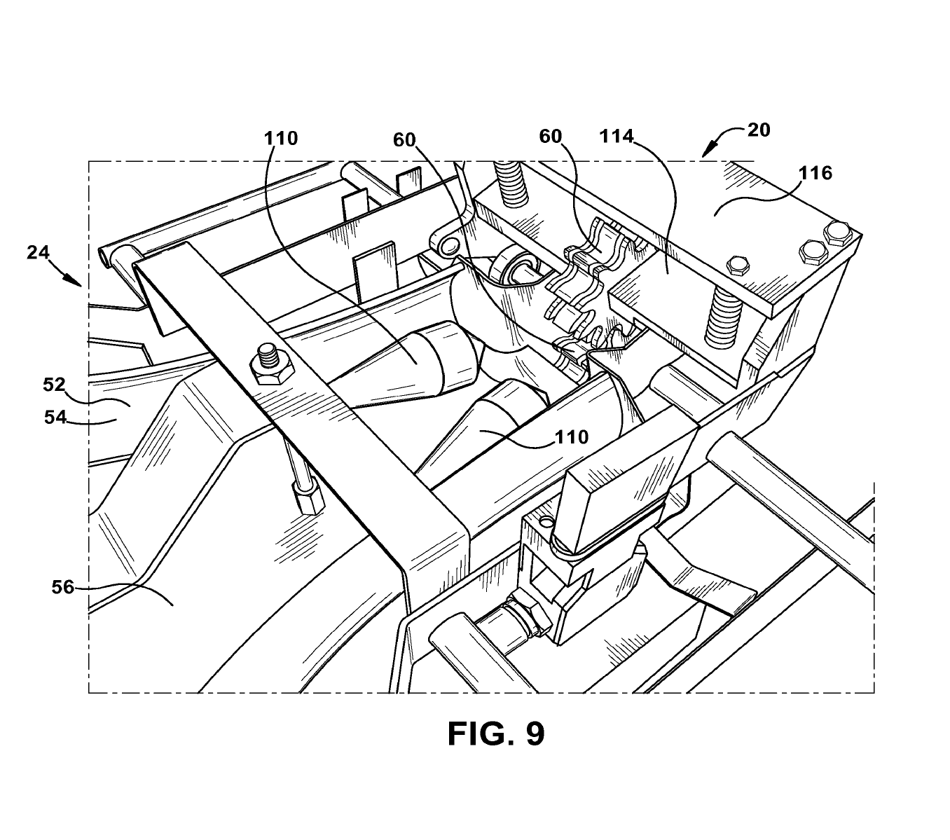

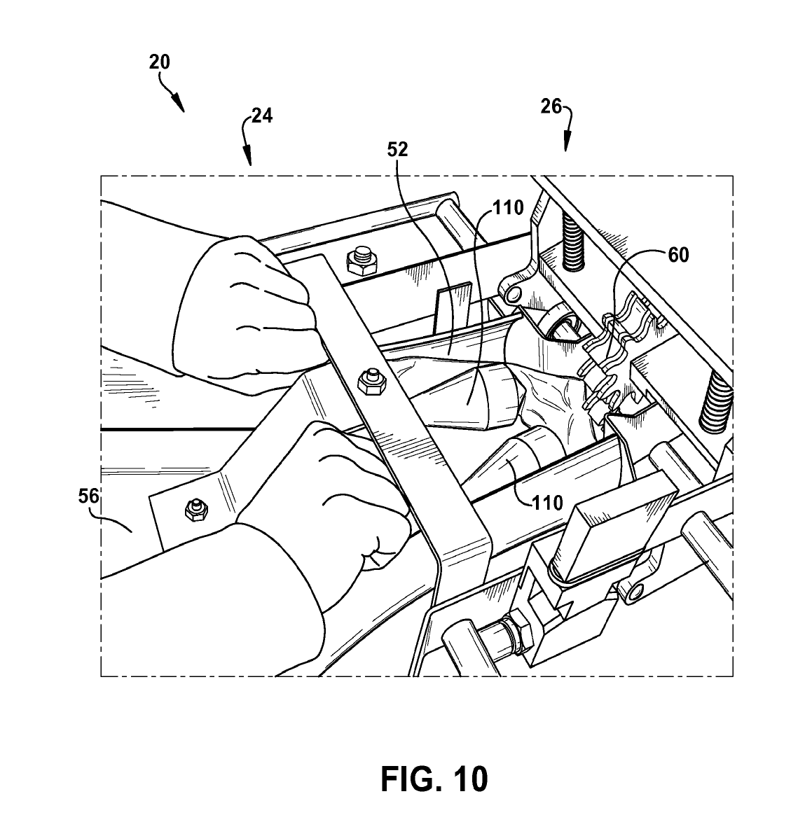

FIGS. 9-11 show a portion of the forming assembly 24 and the feeding/connecting assembly 26. As shown in FIG. 9, the forming assembly 24 includes the converging chute 52 and the forming tray 56. In conjunction with the forming tray 56, the forming assembly 24 has a pair of expanding cones 110 toward a downstream end. When a new supply of sheet stock material is fed into the forming assembly 22, as shown in FIG. 10, the stock material passes between the forming tray 56 and the converging chute 52 to the nip of the rotating members 60 in the feeding/connecting assembly 26. When the feeding/connecting assembly 26 is engaged, the rotating members 60 rotate and draw the sheet material along the path therebetween.

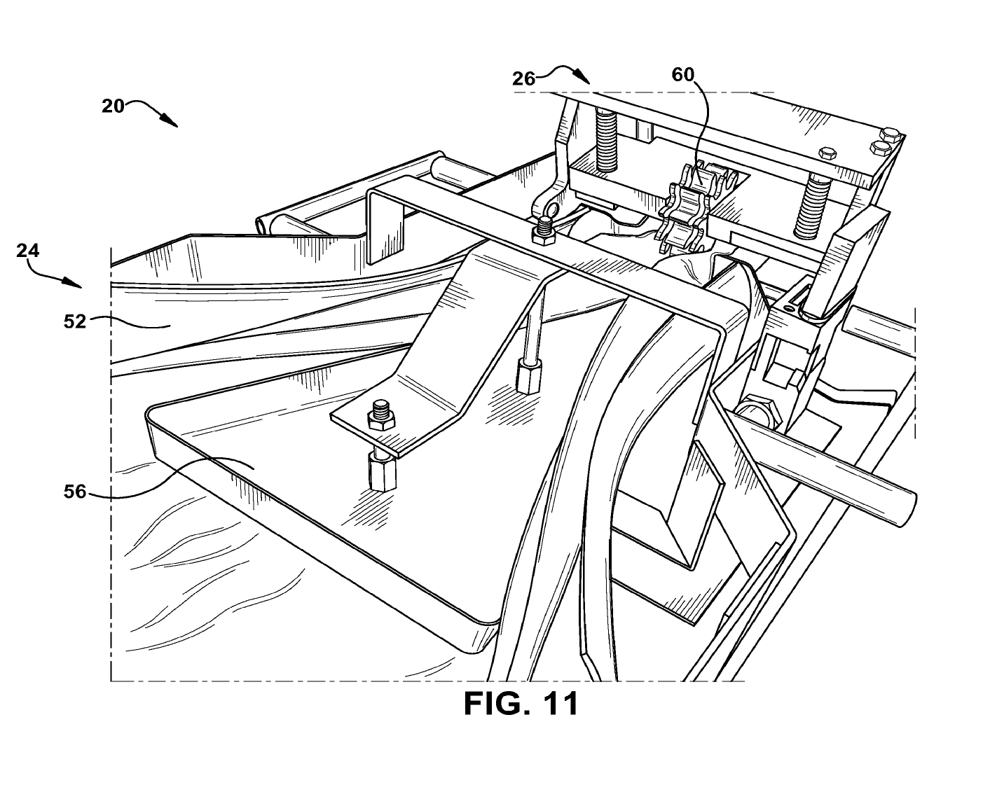

As the stock material is pulled through the forming assembly 24 by the rotating members 60 in the feeding/connecting assembly 26, lateral portions of the sheet material are turned inwardly by the sides 54 of the chute 52. Those lateral portions turn in and pass over lateral sides of the forming tray 56 and around the expanding cones 110 in the manner shown in FIG. 11 to form the overlapping central layers and crumpled lateral portions that make up the strip of dunnage. As mentioned above, the feeding/connecting assembly 26 not only draws the stock material through the forming assembly 24, but also connects the overlapping layers in the center of the strip as the strip travels between the rotating members 60.

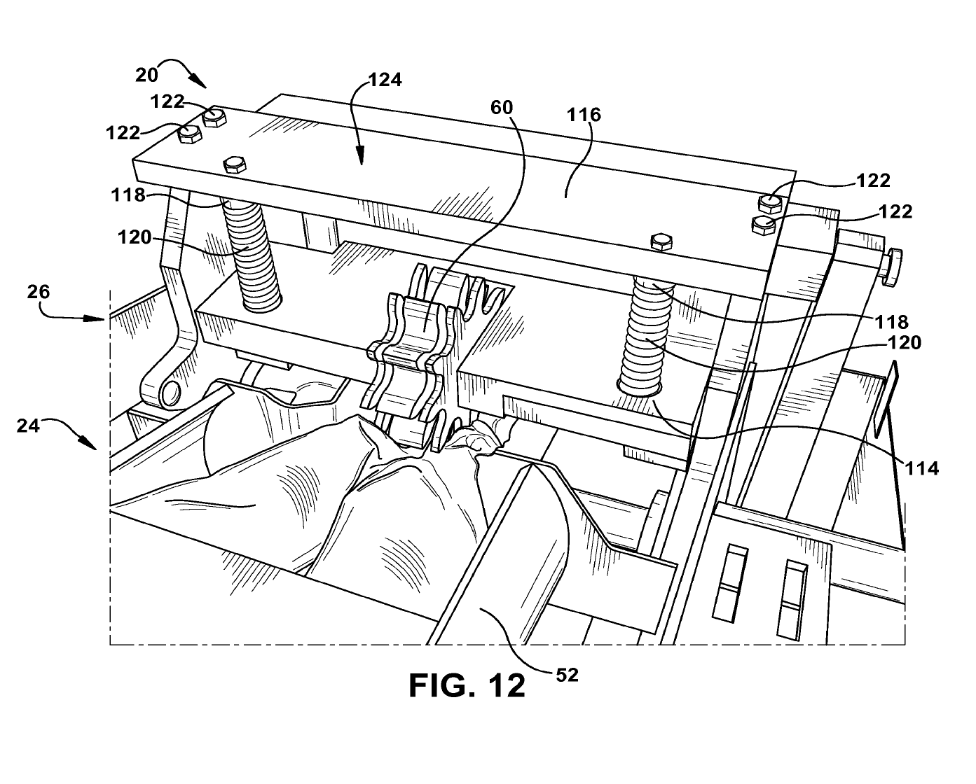

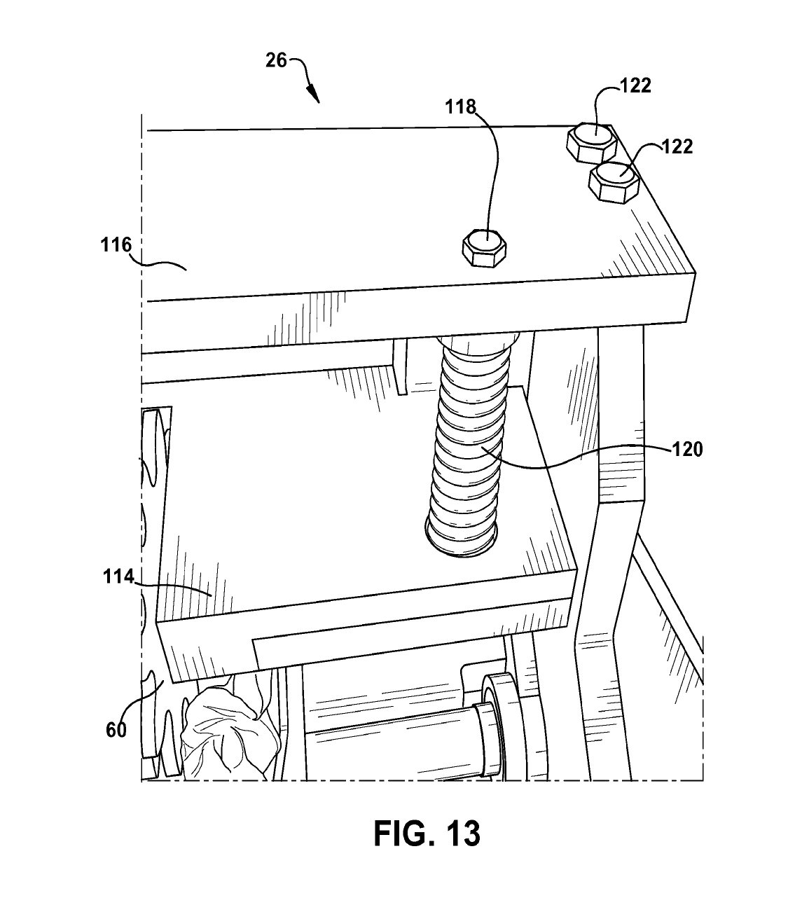

As shown in FIGS. 12 and 13, the feeding/connecting assembly 26 also has several unique features. In addition to the rotating members 60, the feeding/connecting assembly 26 includes a guide chute 112 that bounds the path between the rotating members 60. Additionally, one of the rotating members 60 and a portion 114 of the chute are mounted for common movement toward and away from the other rotating member and another portion of the chute. The movable rotating member 60 is coupled to the movable portion 114 of the chute for rotation relate to the movable portion 114 of chute. Thus the movable rotating member 60 and movable portion of the chute 114, in this case the top portion and upper rotating member, float relative to the other rotating member and the other portion or portions of the chute 112. This helps to minimize or prevent stock material from jamming between the movable rotating member and the associated portion of the chute.

The floating rotating member 60 and the floating portion 114 of the chute 112 are biased away from a portion of the machine's frame toward the other rotating member and the remainder of the chute. In particular, the floating portion 114 of the chute supports the adjacent rotating member 60, and is coupled to a cross-member 116 of the frame of the machine 20 by a pair of guide rods 118 that pass through the floating portion 114 of the chute. The guide rods 118 determine the maximum displacement of the floating portion 114 of the chute relative to the cross-member 116. A biasing element, a pair of springs 120 supported by the guide rods 118, bias the floating portion 114 of the chute and the floating rotating member 60 toward the opposing rotating member and another portion of the chute.

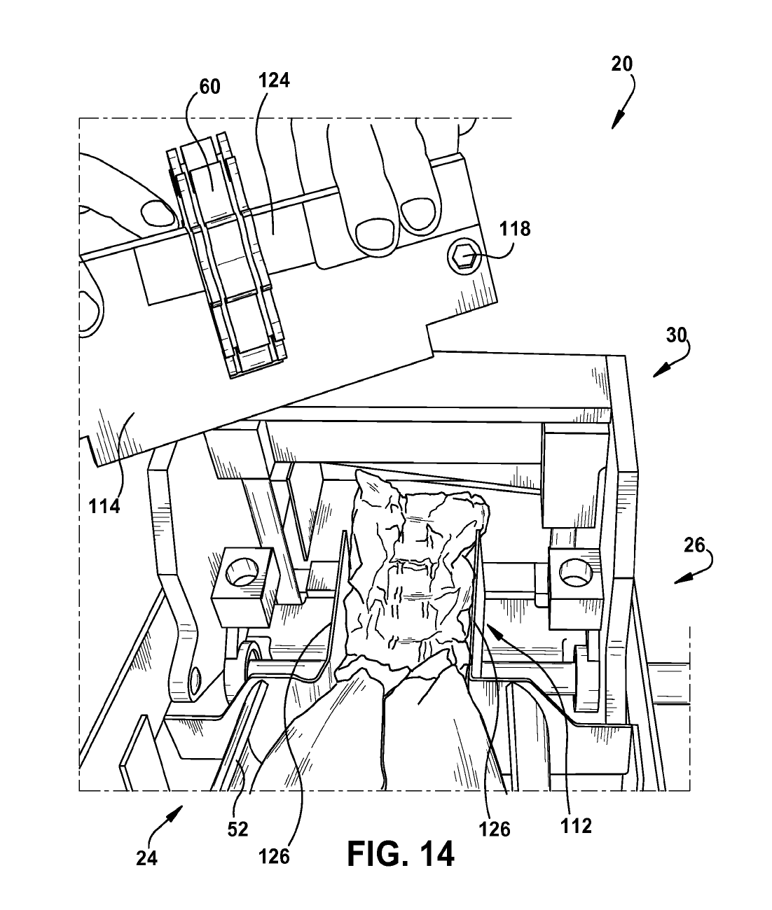

The cross-member 116, the guide rods 118, the springs 120, the floating portion 114 of the chute, and the floating rotating member 60 form part of a subassembly 124 that can be removed from the conversion assembly 32 as a unit separate from another portion of the chute 112 and the other rotating member. This subassembly is coupled to the frame of the machine 20 by several bolts 122 that secure the cross-member 116 to the rest of the frame. Removing those bolts 122 allows the entire subassembly 124 to be removed as a unit, as shown in FIG. 14.

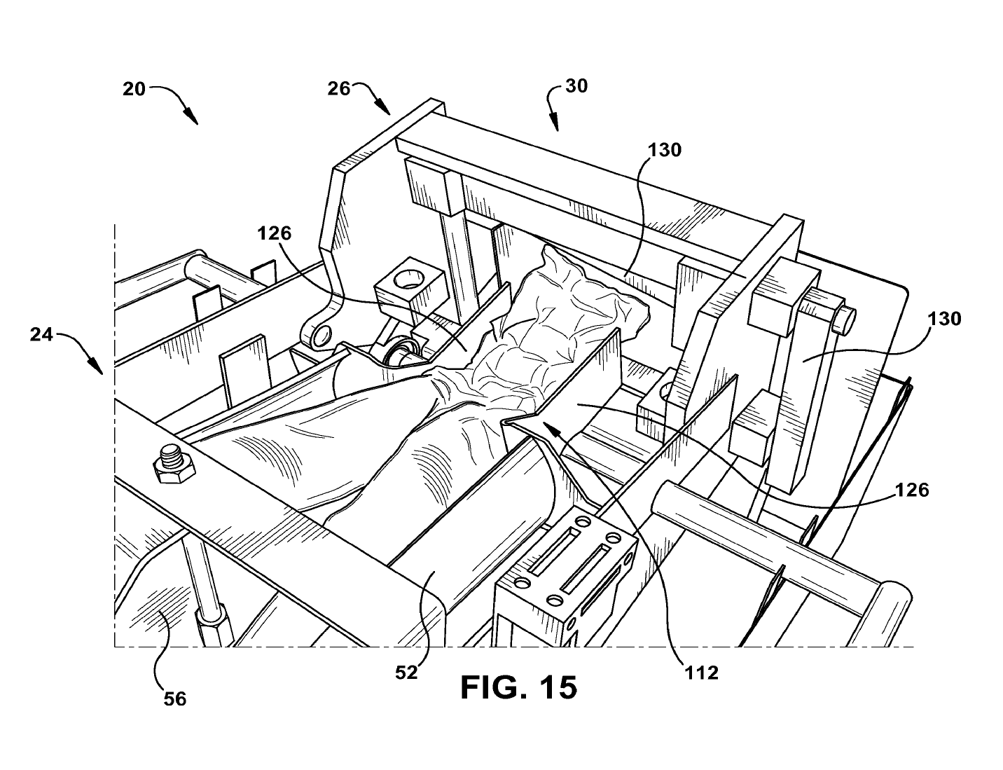

In FIGS. 14 and 15, with the feeding/connecting subassembly 124 removed, the rest of the guide chute 112 is exposed for inspection and maintenance. The guide chute 112 includes at least two portions that are movable relative to each other, and each portion maintains a fixed position relative to an axis of a respective rotating member. In the illustrated embodiment, orthogonal pairs of walls define the chute 112, which has a generally rectangular cross-section, and the movable portion 114 of the chute includes at least one wall. The chute 112 includes transversely-spaced side walls 126 and a bottom wall (not shown) under the strip of dunnage and around the other, non-floating rotating member (not shown). The guide chute 112 thus bounds and helps to define the path of the strip of dunnage through the feeding/connecting assembly 26. This removable subassembly 124 facilitates opening the space around the rotating members 60 for inspection and maintenance, as well as making it easier to clear stock material from the conversion assembly 32 as it enters and leaves the feeding/connecting assembly 26 and travels to the severing assembly 30.

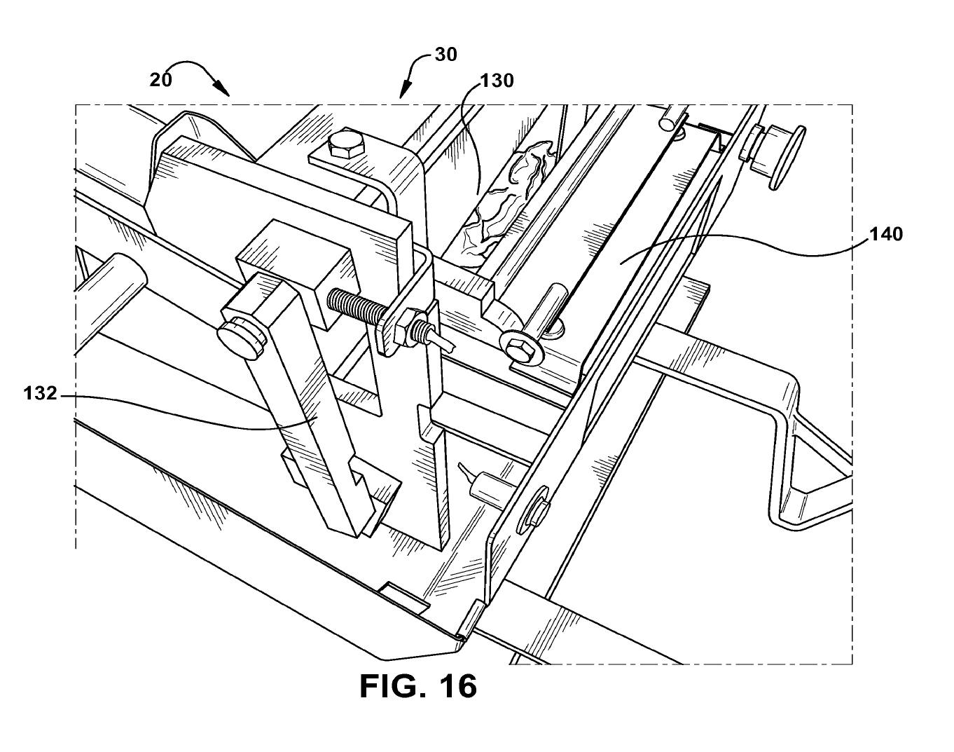

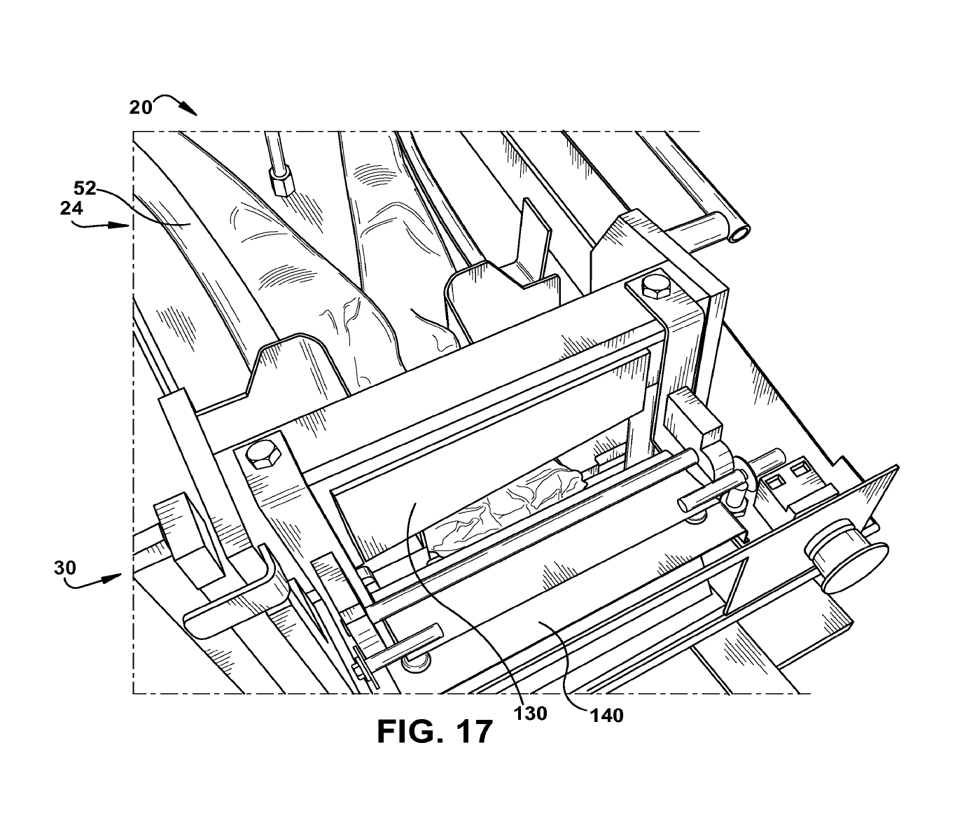

Further details of the severing assembly 30 can be seen in FIGS. 16 and 17. The severing assembly 30 severs, such as by cutting, discrete lengths of dunnage from the strip of dunnage fed through the feeding/connecting assembly 26. The illustrated severing assembly 30 includes a guillotine cutting blade 130 that is angled to slice through the dunnage strip to produce dunnage products of a desired length. Typically the feeding/connecting assembly 26 is stopped before the severing assembly 30 is activated, so a common motor (not shown) can drive both the cutting blade 130 and the rotating members 60 of the feeding/connecting assembly 26. Alternatively, separate motors can drive the severing and feeding/connecting operations. A crank arm 132 connects a motor (not shown) to the cutting blade 130 is shown in FIG. 16. A similar arm can be provided on the opposite side of the cutting blade. Downstream of the cutting blade 130, the severing assembly 30 includes a post-cutting constraining chute 140 that guides the strip of dunnage through an outlet in the housing and holds the strip while it is being cut.

The dunnage conversion machine thus described provides (i) a floating portion of the guide chute and rotating member that minimize or prevent stock material from jamming between the movable rotating member and the associated portion of the chute; (ii) a subassembly, which includes the floating portion of the chute and the floating rotating member, that can be removed from the conversion assembly as a unit, separate from another portion of the chute and the other rotating member, to open the space around the rotating members for inspection and maintenance, as well as making it easier to clear stock material from the conversion assembly; (iii) a transverse member that defines separate paths for respective plies to take up any slack in one of the plies before it enters the conversion assembly to provide more consistent tension in respective plies and a better quality dunnage product; (iv) a stock supply assembly that includes a pair of laterally-spaced apart supports for optionally supporting a roll of sheet stock material, and a housing that includes a top wall for optionally supporting a stack of sheet stock material between the supports, which makes it easier to support different forms of sheet stock material in a compact space; and (v) a forming assembly having a converging chute that is open on one side, and a housing that substantially encloses the chute that includes a door adjacent the open side of the chute to make it easier to access the inside of the chute for inspection, maintenance, loading a new supply of sheet stock material, and clearing any stock material that has jammed in the conversion assembly.

Although the invention has been shown and described with respect to a certain illustrated embodiment or embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiment or embodiments of the invention.

1. A dunnage conversion machine for converting a sheet stock material into a relatively thicker and less dense dunnage product, comprising:
a conversion assembly including a pair of rotating members to feed stock material along a path between the rotating members, and a chute that bounds the path between the rotating members, where one of the rotating members and a portion of the chute are mounted for common movement toward and away from the other rotating member and other portions of the chute.

2. A machine as set forth in claim 1, where the movable rotating member is coupled to the movable portion of the chute.

3. A machine as set forth in claim 1, where the movable rotating member is rotatable relative to the movable portion of the chute.

4. A machine as set forth in claim 1, where orthogonal pairs of walls define the chute, which has a generally rectangular cross-section, and the movable portion of the chute includes at least one wall.

5. A machine as set forth in claim 1, where the machine includes a frame and the movable rotating member and the movable portion of the chute are biased away from a portion of the frame toward the other rotating member and the remainder of the chute.

6. A machine as set forth in claim 1, where the movable portion of the chute and the movable rotating member are part of a subassembly that can be removed from the conversion assembly as a unit separate from another portion of the chute and the other rotating member.

7. A dunnage conversion machine for converting a sheet stock material into a relatively thicker and less dense dunnage product, comprising:
a conversion assembly that includes a pair of rotating members mounted for rotation about respective axes to feed stock material along a path between the rotating members, and a chute that bounds the path,
where a portion of the chute and one of the rotating members are part of a subassembly that can be removed from the conversion assembly as a unit separate from another portion of the chute and the other rotating member.

8. A machine as set forth in claim 7, where the chute includes at least two portions that are movable relative to each other, each portion maintaining a fixed position relative to an axis of a respective rotating member, the subassembly including one portion of the chute and the respective rotating member.

9. A machine as set forth in claim 7, where the subassembly includes a biasing element that biases the rotating member toward the opposing rotating member.

10. A machine as set forth in claim 7, where the subassembly includes a biasing element that biases the movable portion of the chute toward the opposing rotating member and another portion of the chute.

11. A machine as set forth in claim 7, where the conversion assembly includes a forming assembly that forms a sheet stock material into a strip of dunnage.

12. A machine as set forth in claim 7, where the conversion assembly includes a frame and one of the rotating members is coupled to the frame.

13. A machine as set forth in claim 7, where one of the rotating members and a portion of the chute are mounted for common movement toward and away from the other rotating member and another portion of the chute.

14. A machine as set forth in claim 13, where the machine includes a frame and the movable rotating member and the movable portion of the chute are biased away from a portion of the frame toward the other rotating member and the remainder of the chute.

15. A dunnage conversion machine for converting a roll of multi-ply sheet stock material into a relatively thicker and less dense dunnage product, comprising:
a frame, a conversion assembly mounted to the frame to convert the stock material into a dunnage product, and a stock supply assembly mounted to the frame upstream of the conversion assembly, the stock supply assembly including a transverse member that defines separate paths for respective plies from a support for a roll of sheet stock material to a common transverse member at an upstream end of the conversion assembly,
where one path extends substantially vertically downward as it approaches the transverse member and substantially vertically upward as it leaves the transverse member to define a U-shape path from the support to the common transverse member.

16. A dunnage conversion machine for converting a stack of fan-folded sheet stock material into a relatively thicker and less dense dunnage product, comprising:
a conversion assembly for converting the stock material into a dunnage product as the stock material moves through the conversion assembly from an upstream end toward a downstream end,
a constant-entry member upstream of the conversion assembly transverse an upstream-to-downstream direction that defines a constant path to the upstream end of the conversion assembly, and
a housing containing a portion of the conversion assembly, the housing having a top wall offset along an axis from the constant-entry member, and a platform for supporting a stack of sheet stock material to be delivered to the constant-entry member.

17. A dunnage conversion machine for converting a stack of fan-folded sheet stock material into a relatively thicker and less dense dunnage product, comprising:
a conversion assembly for converting the stock material into a dunnage product,
a stock supply assembly for supplying sheet stock material to the conversion assembly, the stock supply assembly including a pair of laterally-spaced apart supports for optionally supporting a roll of sheet stock material, and
a housing containing a portion of the conversion assembly, the housing having a top wall for optionally supporting a stack of sheet stock material between the supports.

18. A dunnage conversion machine for converting a sheet stock material into a dunnage product, comprising
a conversion assembly with a feed mechanism that feeds stock material through the conversion assembly and a chute for guiding stock material to the feed mechanism, the chute defining a path for the stock material and being open on one side;
and a housing that substantially encloses the chute, where the housing includes a door adjacent the open side of the chute.

19. A machine as set forth in claim 18, where the door includes at least one panel.
